(19) United States
(12) Patent Application Publication
(10) Pub. No.: US 2015/0137534 A1
(43) Pub. Date: May 21, 2015

(54) UNIVERSAL BARRICADE FOR ENTRY DOORS

(71) Applicants: Jon C. Brunke, Wilmington, OH (US); Ronald L. Cravens, Wilmington, OH (US)

(72) Inventors: Jon C. Brunke, Wilmington, OH (US); Ronald L. Cravens, Wilmington, OH (US)

(21) Appl. No.: 14/548,689

(22) Filed: Nov. 20, 2014

Related U.S. Application Data
(60) Provisional application No. 61/906,678, filed on Nov. 20, 2013.

(51) Int. Cl. E05C 19/18

(52) U.S. Cl. CPC E05C 19/188; E05C 19/182; E05C 19/184
USPC 292/295

(57) ABSTRACT

A portable entry door barricade is provided to temporarily hold a door shut against a corresponding doorframe. The entry door barricade comprises in general, an elongate bar and a channel lock. The elongate bar has a major length that extends a length at least as long as a span between opposing jams of the doorframe. The channel lock extends from the elongate bar in a direction perpendicular to the major length such that when the elongate bar is positioned relative to the doorframe and the door is closed against the doorframe, the channel lock extends to the side of the door opposite the elongate bar.

### CROSS REFERENCE TO RELATED APPLICATIONS

This application claims the benefit of U.S. Provisional Patent Application No. 61/906,678, filed Nov. 20, 2013, entitled UNIVERSAL BARRICADE FOR ENTRY DOORS, the disclosure of which is hereby incorporated by reference.

### BACKGROUND

Various aspects of the present disclosure relate to an entry door barricade that can be quickly and effortlessly deployed to barricade an entry door. The entry door barricade can also be quickly and effortlessly removed to allow opening of the entry door, e.g., when the user no longer intends to barricade the entry door.

When outbreaks of violence at buildings such as schools, government offices, businesses, and other occupied locations occur, potential victims located within buildings and/or interior rooms have little time to react in defense of their lives. Such outbreaks pose particular challenges to making provision for the security of occupied rooms because building design specifications, codes, regulations and laws focus on minimum safety goals rather than security considerations. For instance, typical safety goals focus on the types of safety concerns that arise in response to non-manmade issues. As such, security considerations that focus on acts that lead to intentional human violence are largely unaddressed. By way of example, as a result of the vulnerability inherent to many door designs, perpetrators of violent acts have easily moved through hallways and into rooms during the implementation of their of nefarious and heinous acts of violence.

### BRIEF SUMMARY

According to various aspects of the present disclosure, an entry door barricade is provided, which is deployed to temporarily hold a door shut against a corresponding doorframe. The entry door barricade comprises an elongate bar and a channel lock. The elongate bar has a major length, which may be at least as long as a span between opposing jams of the doorframe to which the entry door barricade is to be deployed. The channel lock has an extension member and a bar grasping member that extends out from the extension member. When the entry door barricade is used to temporarily hold the door shut against the corresponding doorframe, the elongate bar is positioned between a surface of the door and the bar grasping member of the channel lock. Here, the surface of the door faces the inside of the room or other area to be barricaded (and is thus referred to herein as an “inside” surface of the door). The channel lock also engages at least one of the doorframe and the door such that the extension member of the channel lock extends under the door.

For instance, the channel lock may further comprise a door grasping member such that the extension member spans between the door grasping member and the bar grasping member. Under this configuration, when the entry door barricade is used to temporarily hold the door shut against the corresponding doorframe, the door grasping member of the channel lock is positioned adjacent to a surface of the door facing outside the room or other area to be barricaded (and is thus referred to herein as an “outside” surface of the door). Moreover, the door sits over the extension member of the channel lock and the elongate bar is positioned between an inside surface of the door and the bar grasping member of the channel lock. This configuration is particularly well suited for an outward swinging door.

As another example, the extension member of the channel lock may comprise a plate having a notch therein to receive a soffit of the corresponding doorframe. Under this configuration, when the entry door barricade is used to temporarily hold the door shut against the corresponding doorframe, the door sits over the plate of the channel lock, the notch of the plate is received in the soffit of the corresponding doorframe, and the elongate bar is positioned between the inside surface of the door and the bar grasping member of the channel lock. This configuration is particularly well suited for an inward swinging door.

According to further aspects of the present disclosure, an entry door barricade is provided to temporarily hold a pair of doors shut against a corresponding doorframe. The entry door barricade comprises an elongate bar having a major length and a channel lock having an extension member that spans between a door grasping member and a bar grasping member. The elongate bar and channel lock are configured such that when positioned relative to a first door and a second door in a double door entryway and both the first door and the second door are closed against the doorframe, the extension member of the channel lock extends under both the first and second doors. Also, the door grasping member of the channel lock contacts an outside surface of each of the first and second doors. Moreover, the elongate bar is positioned between an inside surface of each of the first and second doors, and the bar grasping member of the channel lock.

According to yet further aspects of the present disclosure, an entry door barricade is provided to temporarily hold a pair of doors shut against a corresponding doorframe. The entry door barricade comprises an elongate bar having a major length, a first channel lock and a second channel lock. The first channel lock has an extension member that spans between a door grasping member and bar grasping member. Likewise, the second channel lock has an extension member that spans between a door grasping member and bar grasping member. The elongate bar, the first channel lock and the second channel lock are configured such that when positioned relative to a first door and a second door in a double door entryway and both the first door and the second door are closed against the doorframe, the extension member of the first channel lock extends under the first door.

Also, the extension member of the second channel lock extends under the second door. Additionally, the door grasping member of the first channel lock contacts an outside surface of the first door, and the door grasping member of the second channel lock contacts an outside surface of the second door. Yet further, the elongate bar is positioned between an inside surface of each of the first and second doors on a first side of the elongate bar, and the bar grasping member of the first channel lock and the bar grasping member of the second channel lock on a second side of the elongate bar opposite the first side of the elongate bar.

### BRIEF DESCRIPTION OF THE SEVERAL VIEWS OF THE DRAWINGS

FIG. 1A is a perspective illustration of an entry door barricade for an outward swinging door, according to aspects of the present disclosure herein;

FIG. 1B is a perspective illustration of an entry door barricade for an outward swinging door, according to further aspects of the present disclosure herein;

FIG. 2A an end view of the entry door barricade of FIG. 1A;

FIG. 2B an end view of the entry door barricade of FIG. 1B;

FIG. 3A is a perspective view of the entry door barricade of FIG. 1A installed within a doorframe of an outward swinging door, according to aspects of the present disclosure herein;

FIG. 3B is a perspective view of the entry door barricade of FIG. 1B installed within a doorframe of an outward swinging door, according to aspects of the present disclosure herein;

FIG. 4A is a partial view of the entry door barricade of FIG. 3A showing the entry door barricade relative to a strike jam of the doorframe, according to aspects of the present disclosure herein;

FIG. 4B is a partial view of the entry door barricade of FIG. 3B showing the entry door barricade relative to a strike jam of the doorframe, according to aspects of the present disclosure herein;

FIG. 5A is a partial view of the entry door barricade of FIG. 3A showing the entry door barricade relative to a hinge jam of the doorframe, according to aspects of the present disclosure herein;

FIG. 5B is a partial view of the entry door barricade of FIG. 3B showing the entry door barricade relative to a hinge jam of the doorframe, according to aspects of the present disclosure herein;

FIG. 6A is a view of the outside of the door 32 where the entry door barricade of FIG. 1A has been deployed on the inside of the doorway 30;

FIG. 6B is a view of the outside of the door 32 where the entry door barricade of FIG. 1B has been deployed on the inside of the doorway 30;

FIG. 7 is a perspective view of an entry door barricade for an inward swinging door, according to still further aspects of the present disclosure;

FIG. 8 is a perspective end view of the entry door barricade of FIG. 7;

FIG. 9 is a view illustrating the entry door barricade of FIG. 7 installed on an inward swinging door, according to aspects of the present disclosure;

FIG. 10 is a perspective view illustrating the entry door barricade of FIG. 7 from the outside of the door, according to aspects of the present disclosure herein;

FIG. 11 is a bottom view of the entry door barricade of FIG. 7 to illustrate the channel lock and the bar stop plate relative to the doorframe, according to aspects of the present disclosure;

FIG. 12 is a view of an entry door barricade suitable for use with multiple doors, according to aspects of the present disclosure;

FIG. 13 is a view of the outside of the entry door barricade of FIG. 12, according to aspects of the present disclosure;

FIG. 14 is a view of an entry door barricade suitable for use with multiple doors, according to still further aspects of the present disclosure; and

FIG. 15 is a view of the outside of the entry door barricade of FIG. 14, according to aspects of the present disclosure.

### DETAILED DESCRIPTION

Various aspects of the present disclosure provide a universal entry door barricade that is capable of being deployed in seconds to temporarily barricade a door, thus preventing the door from being opened. Likewise, the entry door barricade can be quickly and easily removed from engagement with a door, e.g., when the user no longer intends to barricade the door, thus allowing normal operation of the door for ingress or egress. The entry door barricade herein is configurable to accommodate both inward and outward swinging doors and requires no modification to the existing door structure. Moreover no modification is required to the area surrounding the door. Still further, the entry door barricade is simple in construction, light weight and can be used by persons of all ages without the use or need for tools, keys, special knowledge, or significant effort.

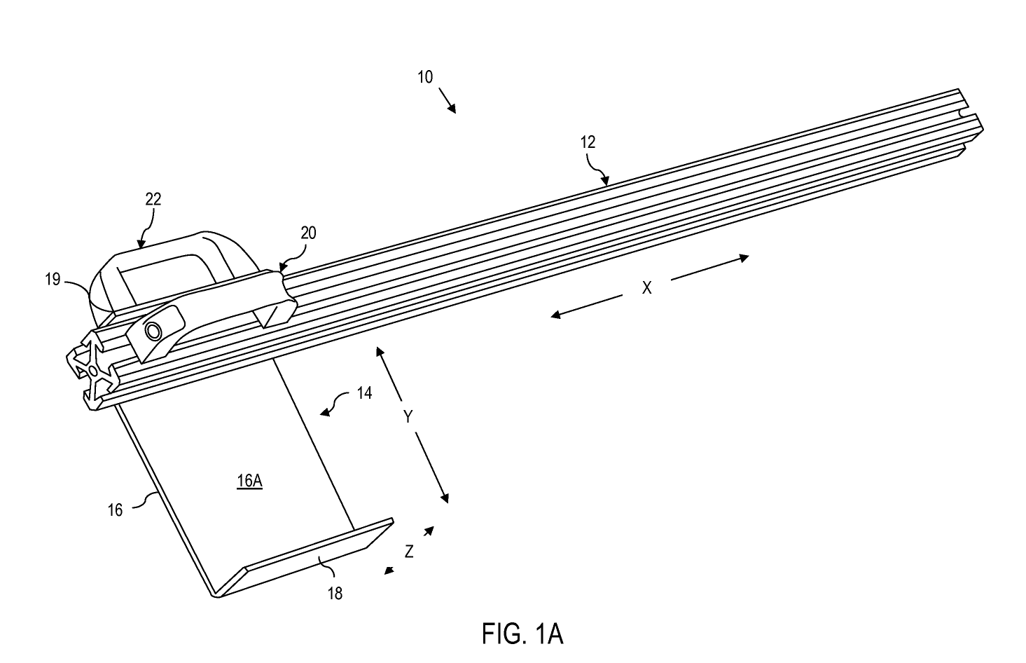

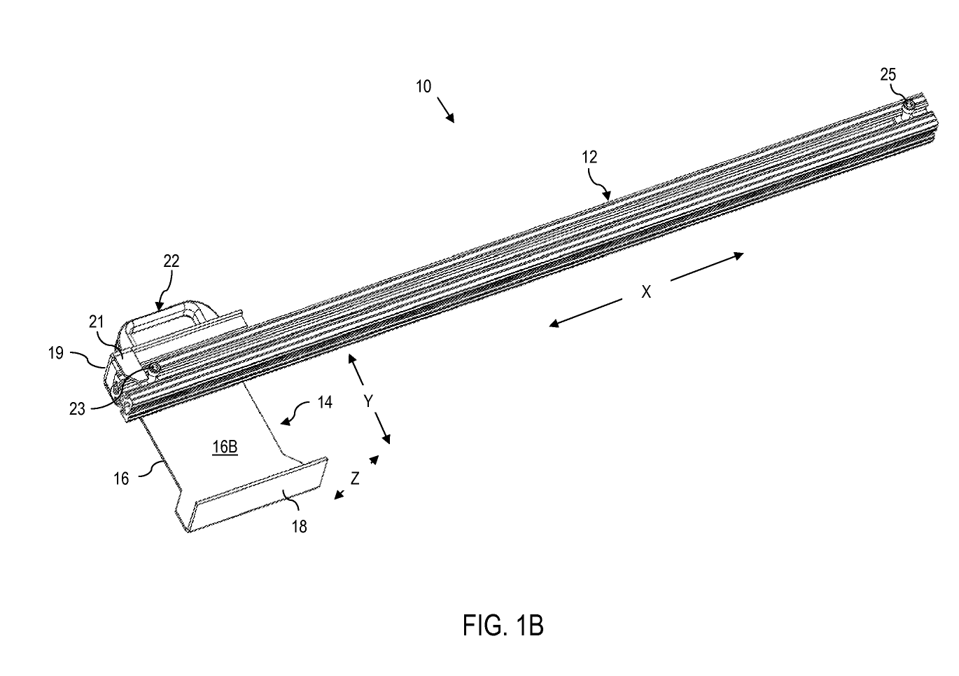

Referring to the drawings and in particular to FIG. 1A, an entry door barricade 10 is illustrated according to aspects of the present disclosure herein. The entry door barricade 10 is used to temporarily hold a door shut against a corresponding doorframe, e.g., to temporarily barricade a room or other area. In general, the entry door barricade 10 comprises an elongate bar 12 and a channel lock 14.

The elongate bar 12 is a rigid structure that extends along a major length, e.g., the X dimension in FIG. 1A. As illustrated, the elongate bar 12 has a generally rectangular cross-section, although other shapes may be utilized. As a non-limiting, but illustrative example, the elongate bar 12 may be constructed of 6105-T5 aluminum bar. However, other materials may be utilized.

The major length of the elongate bar 12 is typically at least as long as a span between opposing jams of a corresponding doorframe. Thus, the elongate bar 12 may be at least 28 inches (71.12 centimeters) long. For instance, entry doors may range from about 30 inches (76.2 centimeters) to about 38 inches (97.52 centimeters) wide. As such, the length of the elongate bar 12 can match or exceed the width of the door to which the elongate bar 12 is designed to barricade. However, in practice, other dimensions may be utilized, e.g., depending upon the features of a doorway for which the entry door barricade 10 is intended.

As a working example, a commercial entry door may be about 38 inches (97.52 centimeters) wide. In this working example, the elongate bar 12 is at least 38 inches long (97.52 centimeters) long (in the X dimension). As a further example, the elongate bar 12 may have a cross-section of 1.5 inches (3.81 centimeters) in the Y dimension by 1.5 inches (3.81 centimeters) in the Z dimension.

In the illustrative example, the channel lock 14 is implemented as a “trough-shaped” (e.g., generally U-shaped) channel member. For instance, the channel lock 14 may be bent from a single piece of material, e.g., ASTM A36 Carbon Steel. The channel lock 14 includes an extension member 16 (seen in the X-Y plane) that spans between a door grasping member 18 (seen in the X-Z plane), and a bar grasping member 19 (also seen in the X-Z plane). The extension member 16 has a major surface 16A that projects outward perpendicular to the elongate bar 12 as illustrated. The door grasping member 18 extends upward from a first end of the extension member 16 and the bar grasping member 19 extends upward from a second end of the extension member 16 opposite the first end.

In the above-working example, the extension member 16 is approximately 4-½ inches (about 11.43 centimeters) long along the X dimension. The depth of the extension member 16 in the direction away from the elongate bar 12 (along the Y dimension) will vary depending upon the door and doorframe configuration. Correspondingly, the door grasping member 18 is approximately 4-½ inches (about 11.43 centimeters) long along the X dimension and approximately 1 inch (about 2.54 centimeters) tall along the Z dimension. Similarly, the bar grasping member 19 is approximately 4-½ inches (about 11.43 centimeters) long along the X dimension and approximately 1 inch (about 2.54 centimeters) tall along the Z dimension. However, the dimensions of the extension member 16 will ultimately vary based upon a number of factors, such as the size of the door, the configuration of the doorframe, and the holding strength required by the particular application.

The door grasping member 18 is illustrated as having a length (along the X dimension) that is the same as the corresponding length of the extension member 16. However, in practice, the length of the door grasping member 18 may alternatively be larger or smaller than the length of the extension member 16 (an example of this is set out with regard to FIG. 1B). The height of the door grasping member 18 (along the Z dimension) is selected according to the desired holding strength for the particular application. Similar considerations apply for the bar grasping member 19.

During use, the channel lock 14 extends from the elongate bar 12 in a direction perpendicular to the major length of the elongate bar 12. Thus, for instance, in FIG. 1A, the channel lock 14 extends in a direction along the Y dimension. The channel lock 14 is dimensioned to allow a corresponding door to sit within the trough (over the extension member 16) such that the outside of the door abuts the door grasping member when the entry door barricade 10 is properly installed on a corresponding door and an attempt is made to forcibly open the door. Thus, in use, the extension member 16 lies in a generally horizontal plane, whereas the door grasping member 18 and bar grasping member 19 each project upward in a generally vertical plane.

The entry door barricade 10 may also include other features. For instance, in illustrative implementations, the elongate bar 12 and the channel lock 14 are handled separately until set up to barricade a door. As such, the entry door barricade 10 may include a first handle 20 that attaches to the top of the elongate bar 12 to make it easy to wield the elongate bar 12. For example, as illustrated in FIG. 1, the first handle 20 is proximate to the channel lock 14, e.g., opposite the major surface 16A of the channel lock 14.

The entry door barricade 10 may also include a second handle 22 that attaches to the back side of the bar grasping member 19 of the channel lock 14. The second handle 22 is provided to make it easy to wield the channel lock 14 independent of the elongate bar 12. Thus, in FIG. 1A, the elongate bar 12 and the channel lock 14 are illustrated in their respective positions when the entry door barricade 10 is in use.

Referring to FIG. 1B, an entry door barricade 10 is illustrated according to further aspects of the present disclosure. The entry door barricade 10 of FIG. 1B is identical to that of FIG. 1A except where otherwise indicated. As such, like elements are indicated with like reference numerals.

Notably, the major surface 16B of the extension member 16 portion of the channel lock 14 is not rectangular. Rather, the major surface 16B includes a flared out portion. For instance, the extension member 16 may comprise at least one projection such that a major surface 16B of the extension member 16 is not rectangular. The flared out portion (e.g., projection) can be used to grab a door jam or create interference with a soffit so as to provide resistance to door entry by securing to both the door and the door frame, as will be described in greater detail herein.

Also, the channel lock 12 includes a stop member 21 that extends from the bar grasping member 19. For instance, the stop member 21 may be implemented as a strike plate that extends from the bar grasping member 19 such that when the entry door barricade 10 is deployed to barricade the door, the strike plate extends over the top of the elongate bar 12. The strike plate may be formed by making approximately a 90 degree bend in the base material used to make the channel lock 14.

The implementation of the entry door barricade 10 of FIG. 1B also includes a first limiter 23 that extends from the top of the elongate bar 12 spaced from, but near a first end of the elongate bar 12. Likewise, an optional, second limiter 25, may be provided so as to extend from the top of the elongate bar 12 spaced from, but near a second end of the elongate bar 12 opposite the first end.

Thus, when the entry door barricade 10 is used to temporarily hold the door shut against the corresponding doorframe, the door grasping member 18 of the channel lock 14 is positioned adjacent to a surface of the door facing outside a room or other area to be barricaded (and is thus referred to herein as an “outside” surface of the door). Also, the door sits over the extension member 16 of the channel lock 14. Still further, the elongate bar is positioned between a surface of the door facing inside the room or other area to be barricaded (and is thus referred to herein as an “inside” surface of the door), and the bar grasping member 19 of the channel lock 14. In this manner, the channel lock 14 is prevented from sliding lengthwise along the major axis of the elongate bar 12 based upon contact between an abutment surface of the stop bar 21 and the limiter 23.

Where the elongate bar 12 includes both limiters 23, 25, the user can engage the elongate bar 12 in two different orientations for ease of use, i.e., the user can flip the elongate bar 12 around so that the stop member 21 of the channel lock 14 engages the limiter 25, if desired. Regardless, the limiter (e.g., limiter 23) in engagement with the abutment surface of the strike plate (stop member 21), prevents the channel lock 14 from sliding along the elongate bar 12, thus securing the channel lock 14 in a desired position, proximate to one end of the elongate bar 12.

Also, as illustrated, a single handle 22 is provided. The handle 22 is on the channel lock 14, although other configurations may be implemented.

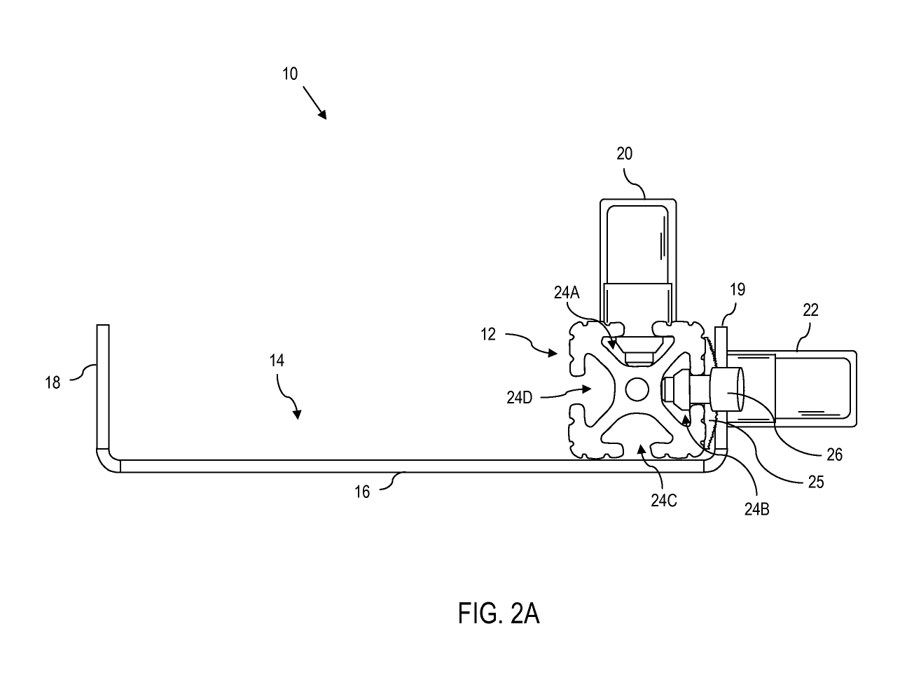

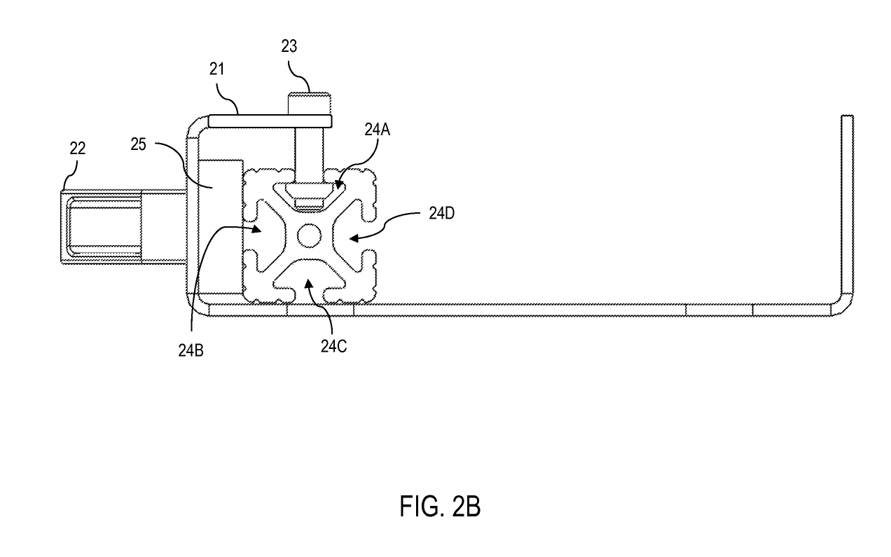

Referring to FIG. 2A, an end view of the entry door barricade 10 of FIG. 1A is illustrated, according to aspects of the present disclosure. In the illustrative, but non-limiting example, the elongate bar 12 comprises an X-shaped cross-section having at least one channel that extends along the major length. For instance, as illustrated, the elongate bar 12 includes four channels 24A, 24B, 24C, and 24D that are defined in cooperation with the X cross-section configuration. While not required, having one or more channels allows rapid and continuous adjustment of the components that attach to the elongate bar 12. For instance, the channel 24A allows a convenient manner to attach the first handle 20 to the elongate bar 12, e.g., by bolting the first handle 20 to the elongate bar 12 through the channel 24A. Moreover, the channel 24A allows a user to optionally adjust the first handle 20 to any desired position along the major length of the elongate bar 12.

In practice, there is likely to be some variability from door to door. As such, a spacer 25 can be installed to act as a shim. The spacer 25 couples between the elongate bar 12 and the channel lock 14 when the entry door barricade 10 is used to temporarily hold a door shut against a corresponding doorframe, to adjust a distance that the channel lock 14 extends from the elongate bar 12. The thickness of the spacer 25 thus serves to ensure a snug fit between the elongate bar and the channel lock 14 when used to hold a corresponding door closed. Moreover, when the channel lock 14 is installed in cooperation with the elongate bar 12 in a doorway, movement by the channel lock 14 along the length of the elongate bar 12 is restricted in part due to friction that is created by the spacer 25.

As illustrated, the spacer 25 includes a projection that is received in (e.g., snaps in, compresses in, slides in, etc.) the channel 24B. As such, the spacer 25 can be installed, relocated, swapped out for a different spacer 25 of different thickness, etc., in a quick and efficient manner. However, other techniques can be utilized to add a shim/spacer as required by a particular application. Optionally, a spacer 25 can also be positioned on a side of the elongate bar 12 facing the inside surface of the door, e.g., by positioning the spacer 25 in the channel 24D. Still further, multiple spacers 25 can be used, e.g., a first spacer in the channel 24B and a second spacer in the channel 24D.

FIG. 2A also illustrates the use of one or more limiters 26. Each limiter 26 is implemented in the illustrative example, as a pin that screws into the channel 24B and projects therefrom slightly. The limiter 26 creates an abutment surface that limits the amount that the channel lock 14 can be adjusted along the major length of the elongate bar 12. The limiter 26 may be adjustably positioned along the major length of the elongate bar 12, presenting an abutment surface that prevents the channel lock 14 from sliding lengthwise along the elongate bar 12 past the limiter 26. For instance, a pair of limiters 26 can be used to set boundaries for adjustment of the channel lock 14 when installed in cooperation with the elongate bar 12. Moreover, implementing each limiter 26 as a screw that insert into the channel 24B, allows continuous adjustment of a desired position for the limiter 26 along the elongate bar 12. This may be desirable for instance, to accommodate left-side or right-side hinged doors.

Referring to FIG. 2B, an end view of the entry door barricade 10 of FIG. 1B is illustrated, according to aspects of the present disclosure. FIG. 2B is similar to FIG. 2A except where otherwise indicated. As such, like elements are indicated with like reference numerals. Instead of limiters 26 as in FIG. 2A, the implementation in FIG. 2B implements a limiter 23, e.g., as a pin that screws into the channel 24A and projects there from slightly. Also, in the illustrative example, the spacer 25 is implemented as a block to show an alternative exemplary configuration.

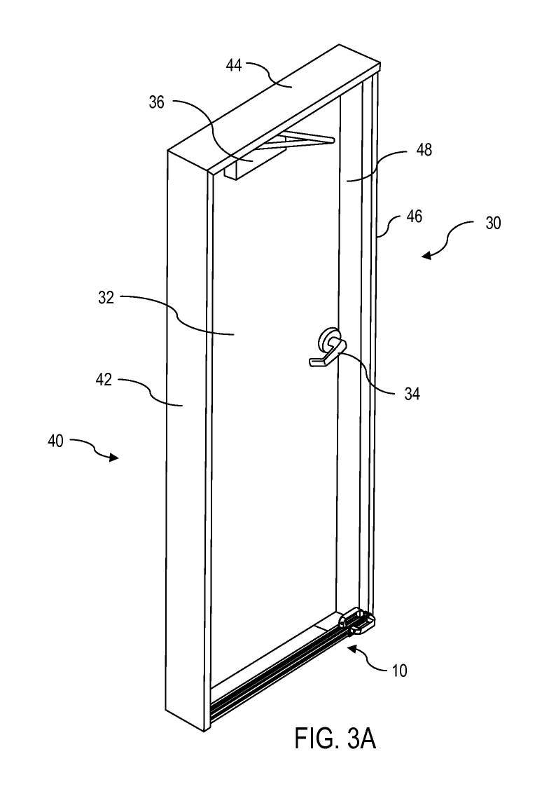

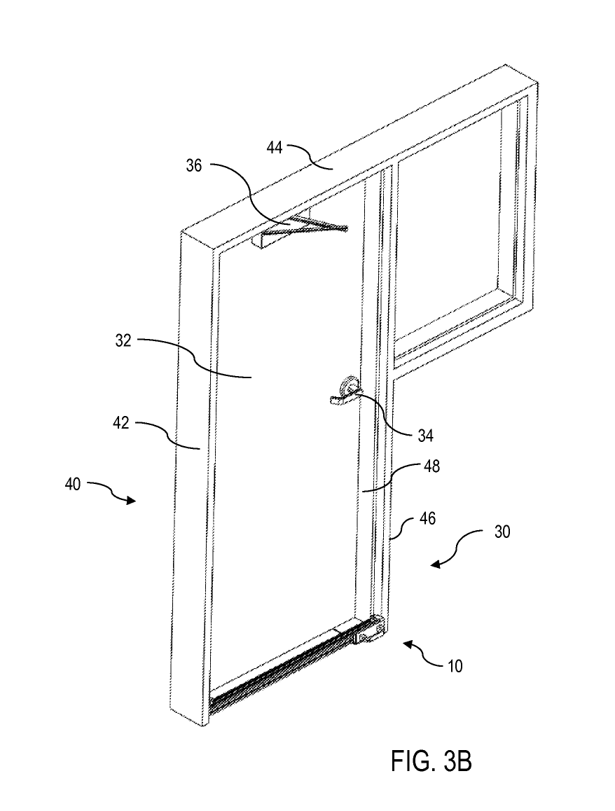

Referring to FIG. 3A, the entry door barricade 10 of FIG. 1A is illustrated installed in a doorway 30. More particularly, a doorway 30 includes a door 32 having a door handle 34 to open and close the door 32, and a closure mechanism 36 that assists with closing the door 32. The door 32 is seated in a doorframe 40 that includes a hinge jam 42, a header jam 44, and a strike jam 46. The hinge jam 42 defines a door jam on the side of the door 32 corresponding to the location of the door hinges, opposite the handle 34. The strike jam 46 defines the door jam on the side of the handle 34 and includes an area where the strike and corresponding door lock of the door handle 34 are installed. Surrounding the doorframe 40 is a soffit 48 that defines a stop, i.e., door abutment surface that keeps the door 32 from swinging through the frame 40. In the illustrative example, the door is an outward opening door.

According to illustrative examples, when the entry door barricade 10 is deployed, the elongate bar 12 has a major length that extends a length at least as long as a span between opposing jams of the doorframe 40. In this regard, the ends of the elongate bar 12 are seated within the doorframe 40 such that the elongate bar 12 abuts a “stop” of the soffit 48 on both the hinge jam 42 and the strike jam 46.

The channel lock 14 is dimensioned to extend from the elongate bar 12 in a direction perpendicular to the major length of the elongate bar 12 and in the direction of the door 32 such that when the elongate bar 12 is positioned relative to the doorframe 40 (e.g., between the hinge jam and strike jam) and the door 32 is closed against the doorframe 40, and the extension member 16 of the channel lock 14 extends under the door 32 to the opposite side of the door relative to the elongate bar. Here, the elongate bar 12 is further positioned between an inside surface of the door 32 and the bar grasping member 19 of the channel lock 14. As such, there may be a “snug” fit between the elongate bar 12, the channel lock 14 and the door 32.

Referring to FIG. 3B, the entry door barricade 10 of FIG. 1B is illustrated installed in the doorway 30. FIG. 3B is similar to FIG. 3A except where otherwise indicated. As such, like elements are indicated with like reference numerals. In this regard, the implementation is analogous to that set out with regard to FIG. 3A. However, because the major surface 16B of the extension member 16 includes a flared out portion, the channel lock 14 is “cornered” proximate to the side of the door 32 having the door handle 34. This configuration allows the channel lock 14 to grab not only the door (via the door grasping surface 18) but also the strike jam 46 and/or soffit 48 of the doorway 30 to provide additional securement.

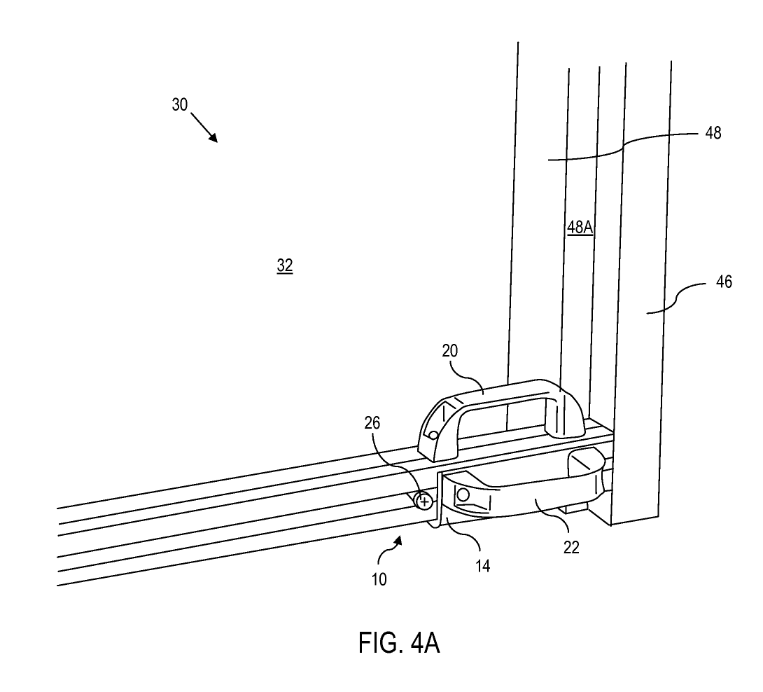

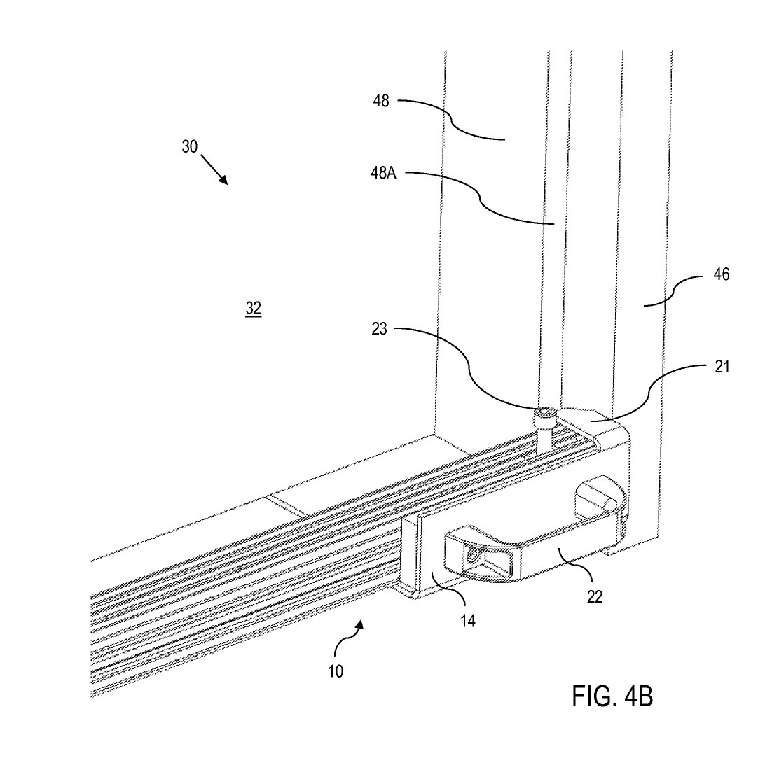

Referring to FIG. 4A, a zoomed-in partial view of the doorway 30 of FIG. 3A illustrates the entry door barricade 10 of FIG. 1A. Notably, the end of the elongate bar 12 proximate to the channel lock 14 is seated against the strike jam 46. Moreover, a side surface of the elongate bar 12 abuts a stop surface 48A of the soffit 48. Also, as illustrated, the channel lock 14 is positioned such that the channel lock 14 is prevented from lateral movement due to the strike jam 46 and the limiter 26. Also, as illustrated, the elongate bar 12 is positioned between an inside surface of the door 32 and the bar grasping member 19 of the channel lock 14.

Referring to FIG. 4B, a zoomed-in partial view of the doorway 30 of FIG. 3B illustrates the entry door barricade 10 of FIG. 1B. FIG. 4B is similar to FIG. 4A except where otherwise indicated. As such, like elements are indicated with like reference numerals. In an analogous manner to that described above, the end of the elongate bar 12 proximate to the channel lock 14 is seated against the strike jam 46. Moreover, a side surface of the elongate bar 12 abuts a stop surface 48A of the soffit 48. Also, as illustrated, the channel lock 14 is prevented from lateral movement along the major length of the elongate bar 12 due to the strike jam 46 of the door frame 40, and the positioning of the stop member 21 between the strike jam 46 the limiter 23.

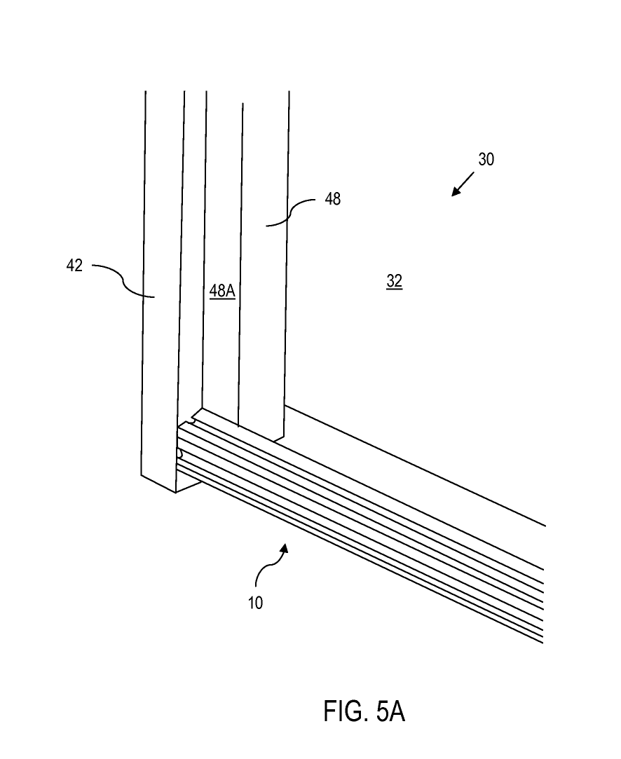

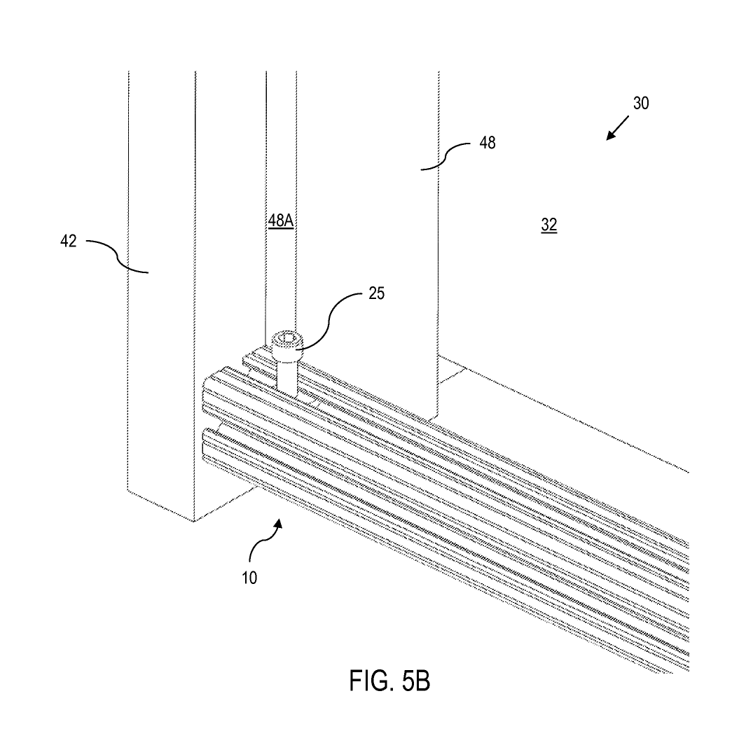

Referring to FIG. 5A, a zoomed-in partial view of the doorway 30 of FIG. 3A and corresponding entry door barricade 10 of FIG. 1A, illustrates that the end of the elongate bar 12 opposite the channel lock 14 is seated against the hinge jam 44. Moreover, in an analogous manner to that described with reference to FIG. 4A, a side surface of the elongate bar 12 abuts a stop surface 48A of the soffit 48.

Referring to FIG. 5B, a zoomed-in partial view of the doorway 30 of FIG. 3B and corresponding entry door barricade 10 of FIG. 1B, illustrates that the end of the elongate bar 12 opposite the channel lock 14 is seated against the hinge jam 44. Moreover, in an analogous manner to that described with reference to FIG. 4B, a side surface of the elongate bar 12 abuts a stop surface 48A of the soffit 48. FIG. 5B also shows the optional limiter 25 for consistency, which is not necessary to temporarily secure the door 30.

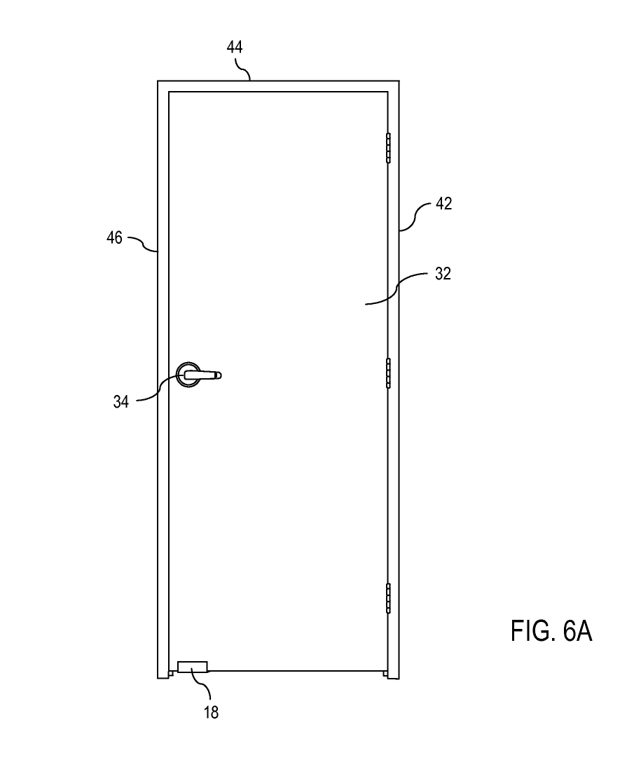

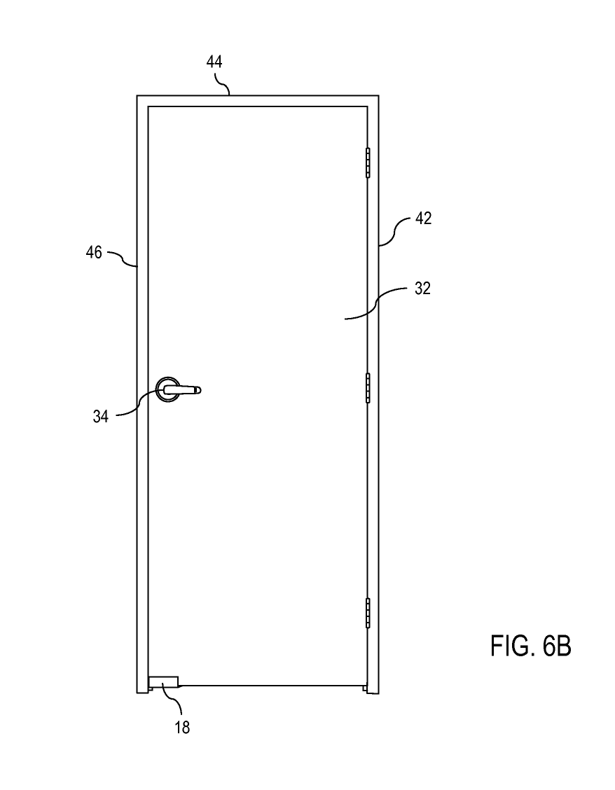

Referring to FIG. 6A, a view illustrates the outside of the door 32 where the entry door barricade of FIG. 1A has been deployed on the inside of the doorway 30. Looking at the entry door barricade 10 from outside the door 32, it can be seen that the door grasping member 18 grasps the outside surface of the door 32, at least when an attempt is made to forcibly open the door 32 against the force of the entry door barricade 10.

Referring to FIG. 6B, a view illustrates the outside of the door 32 where the entry door barricade of FIG. 1B has been deployed on the inside of the doorway 30. Operation in FIG. 6B is identical to FIG. 6A, except that compared to FIG. 6A, the door grasping member 18 in FIG. 6B can be positioned closer to the strike jam 46 because the shape of the extension member 16 (best seen in FIG. 1B) allows the extension member 15 of the channel plate 14 to contour around the soffit 48.

With reference to the previous FIGURES generally, in operation, a user, e.g., a classroom teacher in a crisis situation (such as the presence of an unauthorized or violent intruder in a school), grabs the components of the entry door barricade 10. The elongate bar 12 is detached from the channel lock 14 until brought into cooperation to hold the door 32 shut against the doorframe 40. As such, the user pushes open the door slightly and slips the channel lock 14 under the door 32, then pulls the door 32 shut. For instance, the user can grasp the handle 22 to easily wield the channel lock 14.

Once the door 32 is pulled shut, the user drops the elongate bar 12 down into the channel lock 14. For instance, the user can wield the elongate bar 12 using the handle 20 or otherwise grasp the elongate bar along its length. As such, the elongate bar 12 is positioned between the hinge jam 42 and the strike jam 46, and engages the stop surface 48A of the soffit 48. Moreover, the elongate bar 12 is wedged between the bar grasping member 19 of the channel lock 14 and the inside surface of the door 32. In the event that an assailant armed with a firearm or someone else try to enter while the entry door barricade 10 is in place, any attempts to pull on the door 32 will result in the door 32 failing to open because the channel lock 14 cooperates with the elongate bar 12 and the soffit 48 to prevent the door from swinging open.

However, if an emergency situation arises, the entry door barricade 10 can be quickly removed from the inside to allow the door to open, e.g., to allow an innocent party otherwise trapped in a hallway or other exterior location to enter through the doorway before the entry door barricade 10 is quickly redeployed as described above. For instance, the user lifts the elongate bar 12, e.g., by grasping the handle 20, and lifting upward. The door 32 can be opened while the channel lock 14 remains under the door 32. After the door is re-closed, the user drops the elongate bar 12 back into the channel lock 14 as described above.

The ability to quickly remove the entry door barricade 10 by lifting the elongate bar 12 out of the channel lock 14, e.g., by grasping the handle 20 and lifting upward, permits individuals to quickly open the door 32 once rapidly changing circumstances drive a decision or need to evacuate a secured location.

The entry door barricade 10 is durable and robust against attempts to disable the device through the use of weapons and hand tools. The entry door barricade 10 is even bullet resistant. In a working example, analysis results indicate a force well in excess of 1,000 pounds has been found to be required to compromise example implementations of the entry door barricade 10. This is significantly more force than a typical assailant is capable of producing. Moreover, in illustrative examples, even attempts to shoot out the entry door barricade 10 will result in the assailant wasting time and effort to gain access to the room. For instance, an exemplary implementation has been tested and found with withstand gunshots from 9 mm (millimeter), 0.223 and 12 gauge caliber weapons. In this regard, the selection of the material for the channel lock 14 and the X shape design of the elongate bar 12 allows the entry door barricade 10 to withstand multiple penetrating blows, e.g., via gunshot, without completely compromising the structural integrity of the entry door barricade 10 and its ability to hold a door in its secure position.

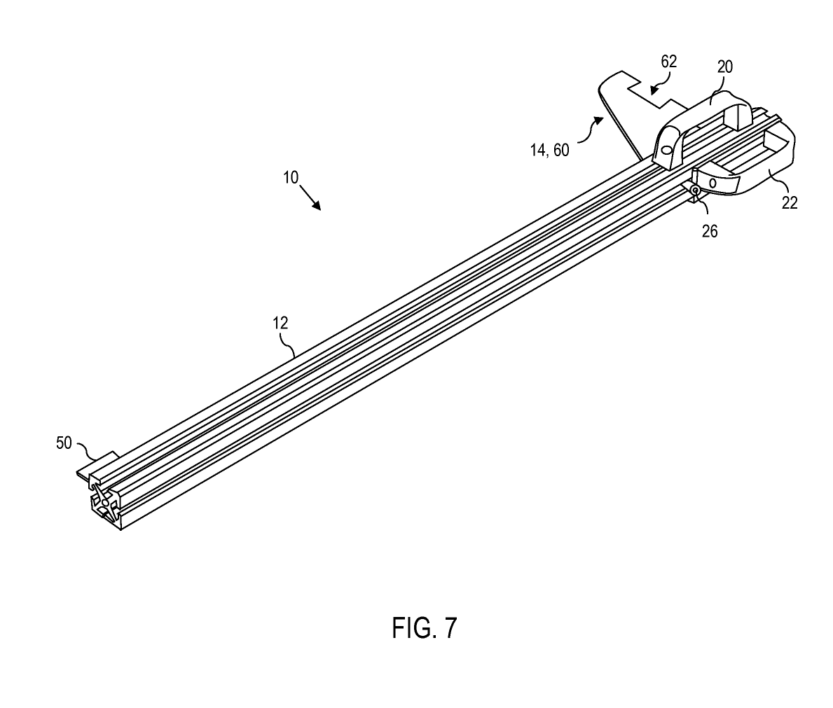

Referring to FIG. 7, an entry door barricade 10 is illustrated, according to further aspects of the present disclosure. The entry door barricade 10 is similar to that described with reference to FIGS. 1A-6B. As such, like elements are indicated with like reference numerals except where otherwise indicated. For instance, like the previous implementations, the illustrated entry door barricade 10 includes an elongate bar 12 and a channel lock 14. The entry door barricade 10 may optionally include one or more handles, e.g., a first handle 20, a second handle 22 or a combination thereof.

The entry door barricade 10 of FIG. 7 differs from the entry door barricade 10 of FIGS. 1A-6B with respect to the configuration of the channel lock 14. In FIG. 7, the channel lock 14 is implemented as an extension member 60 that is generally flat. A bar grasping member analogous to the bar grasping member 19 (FIG. 1A) extends from an end of the extension member 60. However, this implementation does not include a door grasping member. Rather, the extension member 60 includes a notch 62 along an outer edge for receiving a soffit 48 of a corresponding doorframe 40.

The illustrated entry door barricade 10 further includes a bar stop plate 50 located towards the end of the elongale bar 12 opposite the channel lock 14. The bar stop plate 50 can be attached to the elongate bar 12, e.g., using a bolt that tightens into the channel 24C (channel 24C is best illustrated in FIG. 2A). This allows adjustment of the bar stop plate 50 along the elongate bar 12. The bar stop plate 50 is positioned along the elongate bar 12 such that when the entry door barricade 10 is in use securing a door 32, the bar stop plate 50 exerts a force against the soffit 48 on the hinge jam 42.

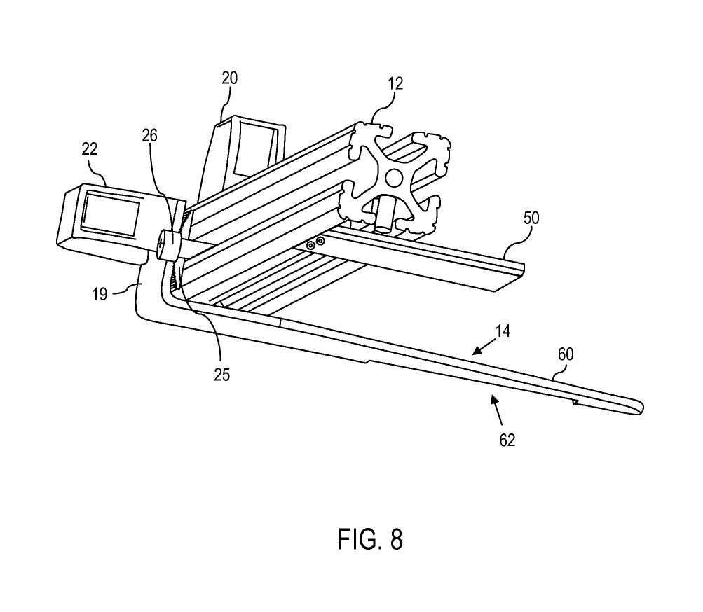

Referring to FIG. 8, a perspective view illustrates a view of the entry door barricade 10 of FIG. 7, looking towards the end of the elongate bar 12 opposite the channel lock 14. As illustrated, the channel lock 14 and the bar stop plate 50 extend from the same side of the elongate bar 12 on opposite ends of the elongate bar 12. Moreover, the bar stop plate 50 does not extend as far laterally out from the elongate bar 12 as the channel lock 14.

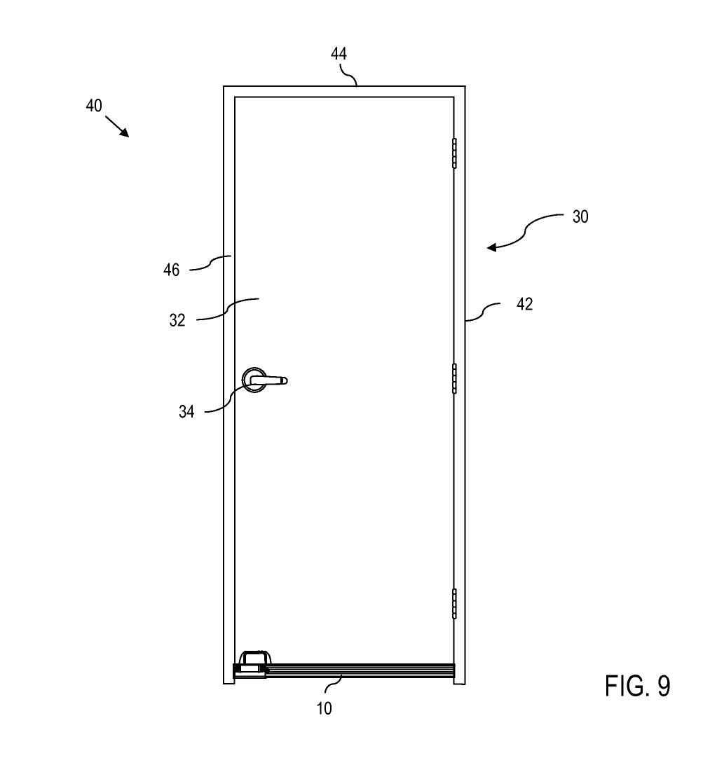

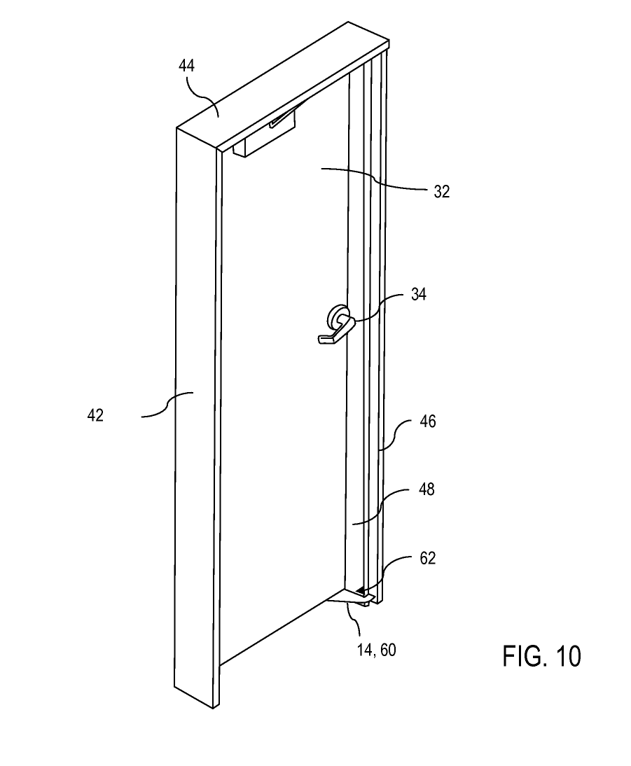

Referring to FIGS. 9-10, the entry door barricade 10 of FIGS. 7-8 is suited for an application of an inward opening doorway 30. For instance, a door 32 having a door handle 34 is seated in a doorframe 40. The doorframe 40 includes a hinge jam 42, a header jam 44 and a strike jam 46. Also, a soffit 48 surrounds the hinge jam 42, header jam 44 and strike jam 46. In this regard, the doorway 30 is similar to the doorway 30 of FIG. 3A and FIG. 3B. However, in FIG. 10, the door 32 is an inward opening door, compared to the outward opening door 32 of FIG. 3A and FIG. 3B.

Referring specifically to FIG. 9, the entry door barricade 10 is installed on the inside of the doorframe 40. For instance, to use the entry door barricade 10, a user grabs the handle 22 of the channel lock 14, and slips the channel lock 14 under the door 32 in cooperation with the strike jam 46. The elongate bar 12 is then dropped into the channel lock 14 such that the stop plate 50 abuts the hinge jam 42 to secure the door 32.

Referring to FIG. 10, the outside of the door 32 is illustrated. Note that when the entry door barricade 10 is installed in the doorway 30, the extension member 60 slips underneath the door 32 and that the notch 62 receives the soffit 48 of the doorframe 40.

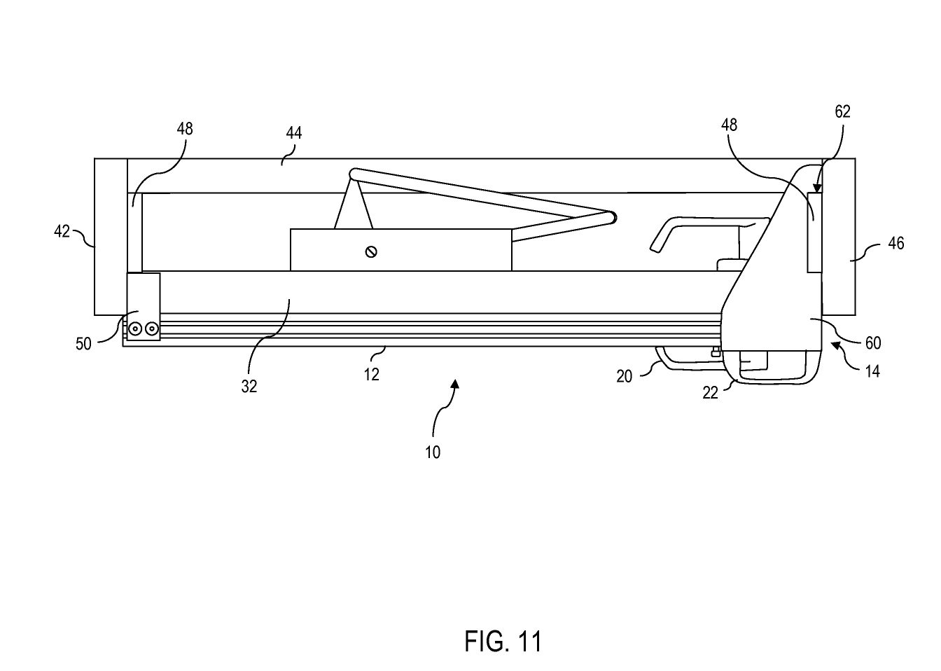

Referring to FIG. 11, a view is illustrated looking up towards the bottom of the doorway 30. When the entry door barricade 10 is installed, the channel lock 14 extends underneath the door 32 such that the extension member 60 reaches under the bottom of the door 32 and the notch 62 is received around the soffit 48. The bar stop plate 50 extends out to mate against the hinge jam 42 and soffit 48. The elongate bar 12 is positioned between the inside surface of the door 32 and the bar grasping member 19 of the channel lock 14.

The lip of the notch 62 of the channel lock 14 engaging the soffit 48 prevents an intruder from opening the door 32. Moreover, the entry door barricade 10 cannot be removed from outside the doorway 30, as noted in greater detail herein. However, a user on the inside can quickly remove the entry door barricade 10. For instance, the user can grasp the first handle 20 and lift the elongate bar 12 out of the channel lock 14.

In illustrative implementations, the bar stop plate 50 may also be used with structures as described with reference to FIGS. 1A-6B. That is, regardless of the configuration of the channel lock 14, the bar stop plate 50 may be secured to the elongate bar 12 where the bar stop plate 50 is positioned on the elongate bar 12 to contact the door jam opposite the channel lock 14 when the entry door barricade 10 is used to barricade the door 30.

With reference to FIGS. 1A-11 generally, various embodiments are provided to address inward and outward swinging doors. Regardless, when the entry door barricade 10 is used to temporarily hold the door 32 shut against the corresponding doorframe 40, the elongate bar 12 is positioned between an inside surface of the door 32 and the bar grasping member 19 of the channel lock 14. The channel lock 14 engages at least one of the doorframe 40 (e.g., hinge jam 42, strike jam 46, soffit 48, etc.) and the door 32 (e.g., the outside surface of the door 32). Moreover, the extension member 16, 60 of the channel lock 14 extends under the door 32.

However, for an outward swinging door, the channel lock 14 further comprises a door grasping member 18 and the entry door barricade 10 is used to temporarily hold the door 32 shut against the corresponding doorframe 40, the door grasping member 18 of the channel lock 14 is positioned adjacent to an outside surface of the door 32, the door 32 sits over the extension member 16 of the channel lock 14 and the elongate bar 12 is positioned between an inside surface of the door 32 and the bar grasping member 19 of the channel lock 14.

Correspondingly, for an inward swinging door, the extension member 60 of the channel lock 14 comprises a plate having a notch 62 therein to receive a soffit 48 of the corresponding doorframe 40 and the entry door barricade 10 is used to temporarily hold the door 32 shut against the corresponding doorframe 40, the door 32 sits over the plate of the channel lock 16, the notch 62 of the plate is received in the soffit 48 of the corresponding doorframe 40 and the elongate bar 12 is positioned between the inside surface of the door 32 and the bar grasping member 19 of the channel lock 14.

Also with reference to FIGS. 1A-11 herein, an entry door barricade 10 is provided, which facilitates the channel lock 14 to be removable and re-attachable to the elongate bar 12 so that the entry door barricade 10 is reconfigurable to accommodate an inward opening door hinged to the left, an inward opening door hinged to the right, an outward opening door hinged to the left, and an outward opening door hinged to the right. In this regard, the elongate bar 12 can be used with any combination of implementations of the channel lock 14. For instance, the same elongate bar 12 can be used at any given time, with the channel lock 14 of FIG. 1A, the channel lock 14 of FIG. 1B, or the channel lock 14 of FIG. 7. Moreover, multiple configurations of the channel lock 14 are provided, which may be selected for instance, depending upon the direction that the door opens.

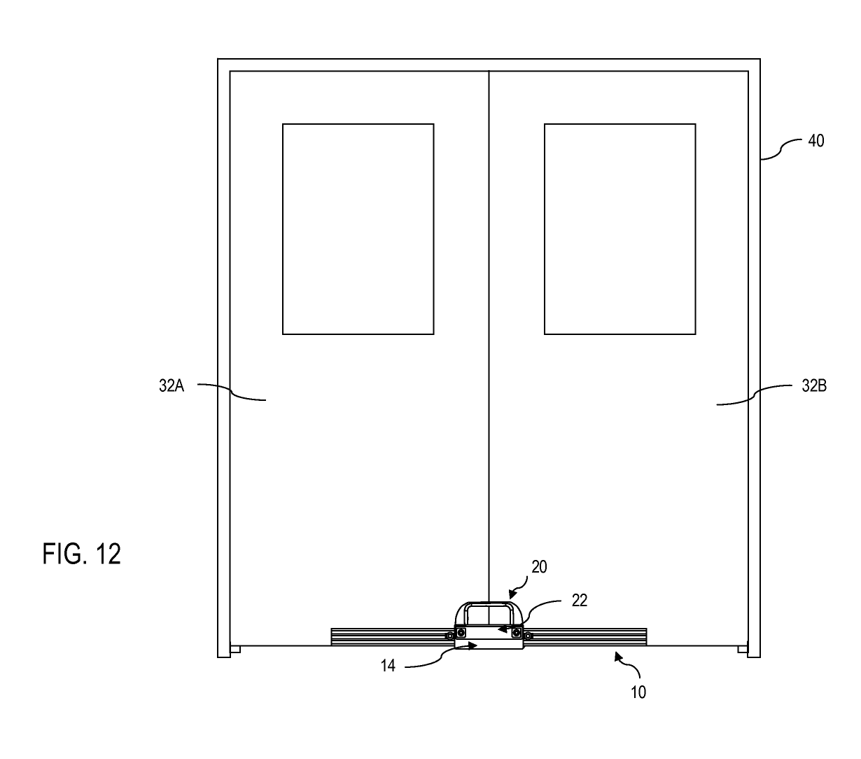

Referring to FIG. 12, the entry door barricade 10 can also be utilized with outward swinging double doors 32A, 32B. As illustrated, in FIG. 12, the entry door barricade 10 is illustrated installed from the inside of a room. In this illustrative example, the entry door barricade 10 is similar to one or more implementations of the entry door barricade 10 described more fully herein. However, the channel lock 14 and the handle 20 have been repositioned to approximately the center of the elongate bar 12. In practice, the width of the channel lock 14 can be slightly wider than a corresponding single door embodiment, e.g., to provide additional strength. In this embodiment, the length of the elongate bar 12 can vary depending upon the particular application. For instance, the length of the elongate bar 12 need not span a corresponding doorframe 40.

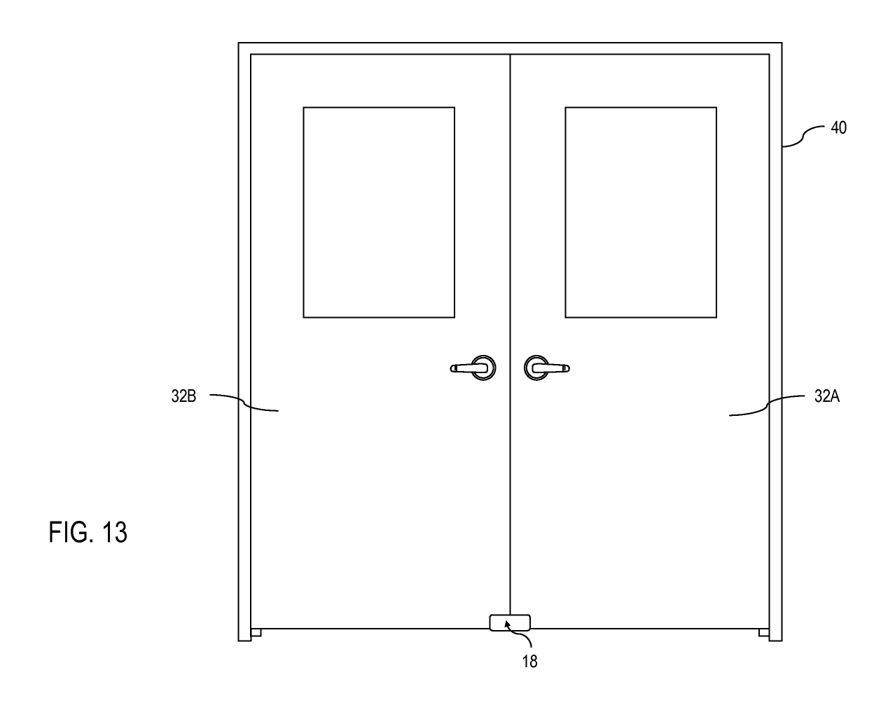

Referring to FIG. 13, the entry door barricade 10 is illustrated from outside the room. In the illustrative implementation, the channel lock 14 and corresponding grasping member 18 grabs both doors 32A, 32B. In use, one of the doors 32A or 32B is slightly opened and the channel lock 14 is slipped into place, so as to span between both doors 32A, 32B. Once the channel lock 14 is in position, the elongate bar 12 is dropped into the channel lock 14. In this implementation, the spacer 25 may be relocated, e.g., into channel 24D (as illustrated in FIG. 2A) so that the spacer 25 is between the elongate bar 12 and the doors 32A, 32B. For instance, where the spacer 25 is a rubber or similar material, additional frictional force is created by the spacer 25 so resist movement of the elongate bar 12 relative to the doors 32A, 32B. Moreover, there may also be a spacer 25 in the channel 24B (as illustrated in FIG. 2) so that additional friction is created between the elongate bar 12 and the bar grasping member 19 of the channel lock 14.

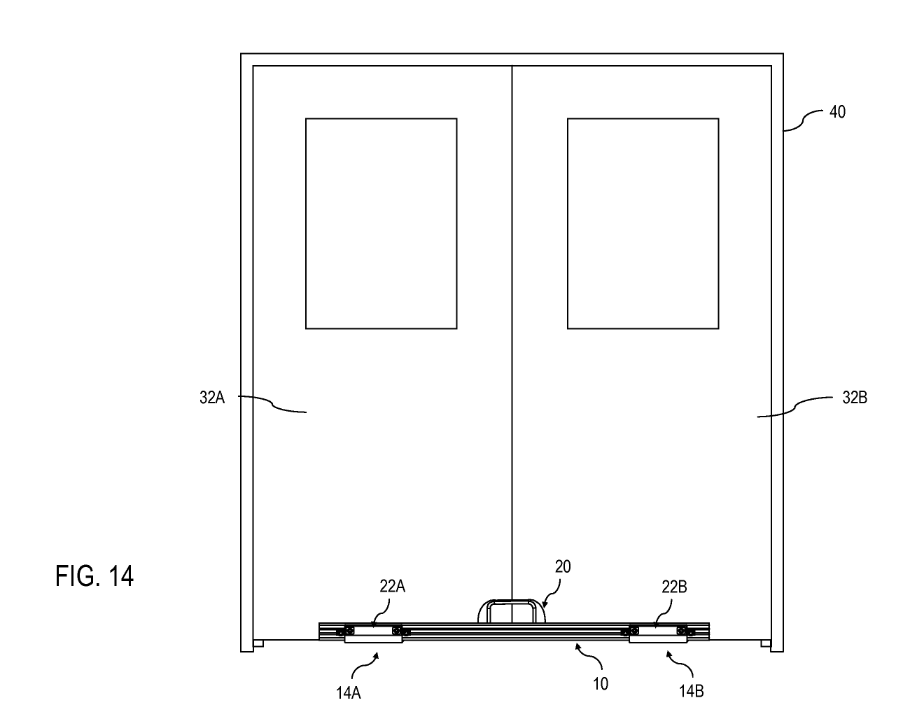

Referring to FIG. 14, the entry door barricade 10 can also be utilized with inward swinging double doors 32A, 32B. As illustrated, in FIG. 14, the entry door barricade 10 is illustrated installed from the inside of a room. In this illustrative example, the entry door barricade 10 is similar to one or more implementations of the entry door barricade 10 set out more fully herein. However, in this embodiment, the first handle 20 is positioned generally toward the center of the elongate bar 12. Moreover, the channel lock 14 has been implemented as two instances, designated as channel lock 14A, and channel lock 14B. Similarly, there are two handles, implemented as handle 22A and handle 22B, respectively.

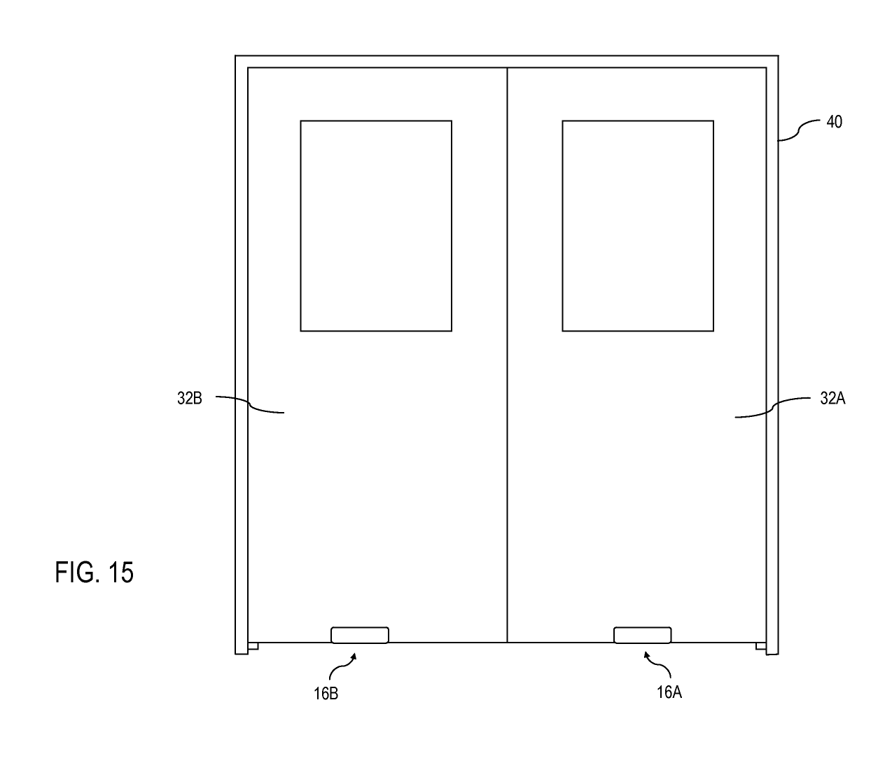

Referring to FIG. 15, the entry door barricade 10 is illustrated from outside the room. In use, each instance of the channel lock 14 is slipped under its associated door, i.e., 32A, 32B respectively. The elongate bar 12 is then dropped into place so that the elongate bar 12 is inserted into each channel lock 14A, 14B. Thus, each instance of the channel lock 14A, 14B is positioned in a spaced relation from the center of the elongate bar such that the first channel lock 14 (and correspondingly, the first grasping member 18A) grabs the first door 32A and the second channel lock 14B (and correspondingly, the second grasping member 18B) grabs the second door 32B. In practice, the width of the channel lock 14 can be slightly wider than a corresponding single door embodiment, e.g., to provide additional strength. Moreover, in this embodiment, the spacer 25 may run the entire length of the elongate bar 12, e.g., in channel 24B. Alternatively, the spacer 25 may run the entire length of the elongate bar 12, e.g., in channel 24D so as to engage the doors 32A, 32B as described more fully herein. Still further, a first spacer 25 can span up to the entirety of the length of the elongate bar 12 on the door-side, e.g., in channel 24D, and a second spacer 25 can extend up the entire length of the elongate bar on the channel plate side, e.g., in channel 24B so that the exact positioning of the channel locks 14A and 14B is not required when being deployed.

In practice, the double door embodiments herein could alternatively use similar structure to that set out in FIG. 7. Also, where the elongate bar 12 extends along or past the doorframe 40, a relatively longer channel lock 14 can be used.

Various aspects of the present disclosure provide an entry door barricade 10 that is capable of being deployed in seconds to temporarily barricade a door. Here, the entry door barricade can be easily stored beside the door for quick and easy access and deployment. Likewise, the entry door barricade 10 can be quickly and easily removed, thus allowing normal operation of the door for ingress or egress. The entry door barricade 10 can be used without any modification to the existing door, doorframe or surrounding. For instance, there is no need to drill holes into the ground adjacent to the door, and no modifications are necessary to the door locks, hinges, etc. As such, the entry door barricade 10 is portable and can be relocated for use with any number of different doors without tools or special devices, and without modification to the door or doorway surroundings.

Moreover, the entry door barricade 10 as set out in greater detail herein, can be utilized with double doors that include a center mullion. Here, depending upon the doorway design and the mullion, it may be necessary to utilize one or more spacers 25, and/or adjust the dimensions of the channel lock 14 in order to function to temporarily barricade the doors, as set out in greater detail herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Aspects of the disclosure were chosen and described in order to best explain the principles of the disclosure and the practical application, and to enable others of ordinary skill in the art to understand the disclosure for various embodiments with various modifications as are suited to the particular use contemplated.

What is claimed is:

1. An entry door barricade to temporarily hold a door shut against a corresponding doorframe, the entry door barricade comprising:
an elongate bar having a major length; and
a channel lock having an extension member and a bar grasping member that extends from the extension member;
wherein, when the entry door barricade is used to temporarily hold the door shut against the corresponding doorframe:
the elongate bar is positioned between an inside surface of the door and the bar grasping member of the channel lock;
the channel lock engages at least one of the doorframe and the door; and
the extension member of the channel lock extends under the door.

2. The entry door barricade of claim 1, wherein:
the major length of the elongate bar is at least 28 inches (71.12 centimeters) long, and covers a span between opposing jams of the doorframe for the door to be barricaded by the entry door barricade.

3. The entry door barricade of claim 1 further comprising:
a spacer that couples between the elongate bar and the channel lock when the entry door barricade is used to temporarily hold the door shut against the corresponding doorframe, where the spacer urges the elongate bar against the inside surface of the door.

4. The entry door barricade of claim 1 further comprising:
a spacer that couples to the elongate bar such that when the elongate bar is used in cooperation with the channel lock to temporarily hold the door shut against the doorframe, the spacer is positioned between the elongate bar and a select one of the inside surface of the door or the channel lock.

5. The entry door barricade of claim 1, wherein:
the elongate bar comprises an X-shaped cross-section having at least one channel that extends along the major length.

6. The entry door barricade of claim 1, wherein:
the channel lock further comprises a door grasping member such that the extension member spans between the door grasping member and the bar grasping member; and
the entry door barricade is configured such that when the entry door barricade is used to temporarily hold the door shut against the corresponding doorframe:
the door grasping member of the channel lock is positioned adjacent to an outside surface of the door;
the door sits over the extension member of the channel lock; and
the elongate bar is positioned between an inside surface of the door and the bar grasping member of the channel lock.

7. The entry door barricade of claim 1, wherein:
the channel lock further comprises a door grasping member such that the extension member spans between the door grasping member and the bar grasping member;
the extension member comprises at least one projection such that a major surface of the extension member is not rectangular; and
the entry door barricade is configured such that when the entry door barricade is used to temporarily hold the door shut against the corresponding doorframe:
the door grasping member of the channel lock is positioned adjacent to an outside surface of the door;
the door sits over the extension member of the channel lock such that the projection contacts at least one of a soffit or jam of the door frame; and
the elongate bar is positioned between an inside surface of the door and the bar grasping member of the channel lock.

8. The entry door barricade of claim 1, wherein:
the extension member of the channel lock comprises a plate having a notch therein to receive a soffit of the corresponding doorframe; and
the entry door barricade is configured such that when the entry door barricade is used to temporarily hold the door shut against the corresponding doorframe:
the door sits over the plate of the channel lock;
the notch of the plate is received in the soffit of the corresponding doorframe; and
the elongate bar is positioned between the inside surface of the door and the bar grasping member of the channel lock.

9. The entry door barricade of claim 1 further comprising:
a bar stop plate secured to the elongate bar, the bar stop plate positioned on the elongate bar to contact the door jam opposite the channel lock when the entry door barricade is used to barricade the door.

10. The entry door barricade of claim 1 further comprising:
at least one limiter that is adjustably positioned along the major length of the elongate bar, the limiter presenting an abutment surface that prevents the channel lock from sliding lengthwise along the major length of the elongate bar past the limiter.

11. The entry door barricade of claim 1 further comprising:
a spacer that couples between a select one of the elongate bar and the channel lock, or the elongate bar and the door, when the entry door barricade is used to temporarily hold the door shut against the corresponding doorframe;
a handle coupled to the channel lock; and
a limiter that is adjustably positioned along the major length of the elongate bar, the limiter presenting an abutment surface that prevents the channel lock from sliding lengthwise along the major length of the elongate bar past the limiter;
wherein:
the channel lock further comprises a door grasping member such that the extension member spans between the door grasping member and the bar grasping member, so as to define a U shape;
the channel lock further comprises a stop member that extends from the bar grasping member, the stop member having an abutment surface;
the entry door barricade is configured such that when the entry door barricade is used to temporarily hold the door shut against the corresponding doorframe:
the door grasping member of the channel lock is positioned adjacent to an outside surface of the door;
the door sits over the extension member of the channel lock;
the elongate bar is positioned between an inside surface of the door and the bar grasping member; and
the channel lock is prevented from sliding lengthwise along the major axis of the elongate bar upon contact between the abutment surface of the stop bar and the limiter.

12. The entry door barricade of claim 11, wherein:
the stop member comprises a strike plate that extends from the bar grasping member such that when the entry door barricade is deployed to barricade the door, the strike plate extends over the top of the elongate bar, and the strike plate is positioned between a door jam and the limiter.

13. The entry door barricade of claim 1 further comprising:
a bar stop plate secured to the elongate bar, the bar stop plate positioned on the elongate bar to contact the door jam opposite the channel lock when the entry door barricade is used to barricade the door;
a spacer that couples between a select one of the elongate bar and the channel lock, or the elongate bar and the door, when the entry door barricade is used to temporarily hold the door shut against the corresponding doorframe; and
a limiter that is adjustably positioned along the major length of the elongate bar, the limiter presenting an abutment surface that prevents the channel lock from sliding lengthwise along the major surface of the elongate bar past the limiter;
wherein:
the extension member of the channel lock comprises a plate having a notch therein to receive a soffit of the corresponding doorframe;
such that when the entry door barricade is used to temporarily hold the door shut against the corresponding doorframe:
the door sits over the plate of the channel lock;
the notch of the plate is received in the soffit of the corresponding doorframe; and
the elongate bar is positioned between the inside surface of the door and the bar grasping member of the channel lock.

14. The entry door barricade of claim 1, wherein:
the channel lock is removable and re-attachable to the elongate bar so that the entry door barricade is reconfigurable to accommodate:
an inward opening door hinged to the left;
an inward opening door hinged to the right;
an outward opening door hinged to the left; and
an outward opening door hinged to the right.

15. The entry door barricade of claim 1, wherein:
the elongate bar is detached from the channel lock until brought into cooperation to hold the door shut against the doorframe.

16. The entry door barricade of claim 1, wherein:
the channel lock further comprises a door grasping member such that the extension member spans between the door grasping member and the bar grasping member, so as to define a U shape;
the door grasping member has a width that spans between both a first door and a second door in a double doorway;
such that when the entry door barricade is used to temporarily hold both the first door and the second door shut against the corresponding doorframe:
the door grasping member of the channel lock is positioned adjacent to an outside surface of the first door and against an outside surface of the second door;
the first door and the second door sit over the extension member of the channel lock; and
the elongate bar is positioned between an inside surface of the first door and an inside surface of the second door on one side, and the bar grasping member of the channel lock on an opposite side.

17. The entry door barricade of claim 1, wherein:
the channel lock defines a first channel lock, further comprising a door grasping member such that the extension member spans between the door grasping member and the bar grasping member, so as to define a general U shape;
further comprising:
a second channel lock having an extension member between a door grasping member and a bar grasping member that extends from the extension member so as to define a general U-shape;
wherein:
when the entry door barricade is used to temporarily hold both a first door and a second door shut against the corresponding doorframe of a double doorway:
the door grasping member of the first channel lock is positioned adjacent to an outside surface of the first door;
the first door sits over the extension member of the first channel lock;
the door grasping member of the second channel lock is positioned adjacent to an outside surface of the second door;
the second door sits over the extension member of the second channel lock;
the elongate bar is positioned between an inside surface of the first door and an inside surface of the second door on one side, and the bar grasping member of the first channel lock and the bar grasping member of the second channel lock on an opposite side.

18. The entry door barricade of claim 1, wherein:
the channel lock defines a first channel lock, the extension member of the first channel lock comprising a plate having a notch therein to receive a soffit of the corresponding doorframe;
further comprising:
a second channel lock having an extension member and a bar grasping member that extends from the extension member, the extension member of the second channel lock comprising a plate having a notch therein to receive a soffit of the corresponding doorframe;
wherein:
when the entry door barricade is used to temporarily hold both a first door and a second door shut against the corresponding doorframe of a double doorway:
the first door sits over the plate of the first channel lock;
the notch of the plate of the first channel lock is received in the soffit adjacent to a first jam of the corresponding doorframe;
the second door sits over the plate of the second channel lock;
the notch of the plate of the second channel lock is received in the soffit adjacent to a second jam of the corresponding doorframe; and
the elongate bar is positioned between an inside surface of the first door and an inside surface of the second door on one side, and the bar grasping member of the first channel lock and the bar grasping member of the second channel lock on an opposite side.

19. An entry door barricade to temporarily hold a pair of doors shut against a corresponding doorframe, the entry door barricade comprising:
an elongate bar having a major length; and
a channel lock having an extension member that spans between a door grasping member and a bar grasping member;
wherein:
the elongate bar and channel lock are further configured such that when positioned relative to a first door and a second door in a double door entryway and both the first door and the second door are closed against the doorframe:
the extension member of the channel lock extends under both the first and second doors;
the door grasping member of the channel lock contacts an outside surface of each of the first and second doors; and
the elongate bar is positioned between an inside surface of each of the first and second doors, and the bar grasping member of the channel lock.

20. An entry door barricade to temporarily hold a pair of doors shut against a doorframe, the entry door barricade comprising:
an elongate bar having a major length;
a first channel lock having an extension member that spans between a door grasping member and bar grasping member; and
a second channel lock having an extension member that spans between a door grasping member and bar grasping member;
wherein:
the elongate bar, the first channel lock and the second channel lock are configured such that when positioned relative to a first door and a second door in a double door entryway and both the first door and the second door are closed against the doorframe:
the extension member of the first channel lock extends under the first door;
the extension member of the second channel lock extends under the second door;
the door grasping member of the first channel lock contacts an outside surface of the first door;
the door grasping member of the second channel lock contacts an outside surface of the second door; and
the elongate bar is positioned between an inside surface of each of the first and second doors on a first side of the elongate bar, and the bar grasping member of the first channel lock and the bar grasping member of the second channel lock on a second side of the elongate bar opposite the first side of the elongate bar.
